(19) United States
(12) Patent Application Publication
(10) Pub. No.: US 2009/0256485 A1
(43) Pub. Date: Oct. 15, 2009

(54) Decorative light string

(75) Inventors: Shih-Chih Huang, Taipei (TW); Ping Yang, Don Guan City (CN)

Correspondence Address: JACKSON WALKER, L.L.P., 112 E. PECAN, SUITE 2400, SAN ANTONIO, TX, 78205, US

(73) Assignee: Jetmax Industrial Ltd.

(21) Appl. No.: 12/082,739

(22) Filed: Apr. 14, 2008

(51) Int. Cl. H05B 37/02

(52) U.S. Cl. 315/185 S

(57) ABSTRACT

A decorative light string has a power connector, at least one lightening unit and a rectifier. The lightening unit is electrically connected to the power connector and has an incandescent bulb set and an LED set. The incandescent bulb set has a primary wire and multiple incandescent bulbs. The LED set has a secondary wire and multiple LEDs. The incandescent bulbs and LEDs are respectively electrically connected to the primary and the secondary wire. The secondary wire is electrically connected and intertwined with primary wire. At least one of the incandescent bulbs of the incandescent bulb set is placed between each two of the LEDs. The rectifier is electrically connected the power connector and each LED set in series. The decorative light string has an advantage of preventing snow to veil LEDs by the heat from the incandescent bulbs when used in the snows.

### BACKGROUND OF THE INVENTION

1. Field of the Invention

The present invention relates to a decorative light string, and more particularly to a decorative light string assembled with incandescent bulbs and light emitting diodes (LEDs).

2. Description of the Prior Arts

A conventional decorative light string for decorating Christmas trees is composed of either multiple incandescent bulbs or multiple LEDs in series via wires independently, since the incandescent bulbs can utilize both alternating current- and direct current-power supplies in contrast to the LEDs can only utilize the later. In comparison to incandescent bulbs being more energy consuming, monotonous and less decorative, the LEDs is capable to emit light of various colors. Therefore, the consumer preferred LED light strings than incandescent light strings due to its advantages of saving energy and having better decorativeness.

However, LEDs radiate less heat, which results in the accumulation of snow on the LED light strings and veiling the LEDs by snow so as to hamper the luminescence and the decorativeness of the LEDs. For the limitation of the LEDs as described above, the LED light strings need to be used in combination with and tied up with the incandescent light strings to decorate the Christmas trees in the snows. In this circumstance, it is more time and money consuming for requiring more labor, wires and electric connectors.

To overcome the shortcomings, the present invention provides a decorative light string to mitigate or obviate the aforementioned problems.

### SUMMARY OF THE INVENTION

To solve the problem that existing decorative light string with LEDs is unable to produce appropriate heat to prevent snow to veil LEDs, the objective of the invention is to provide a decorative light string having incandescent bulb set and LED set intertwined together and share a common electric connector selectively connected to a power source.

The decorative light string comprises a power connector, at least one lightening unit and a rectifier. The at least one lightening unit is electrically connected to the power connector and each one of the at least one lightening unit has an incandescent bulb set and an LED set.

The incandescent bulb set has a primary wire and multiple incandescent bulbs. The primary wire is electrically connected to the power connector. The multiple incandescent bulbs are electrically connected to the primary wire.

The LED set has a secondary wire and multiple LEDs. The secondary wire is electrically connected to the primary wire and being intertwined with primary wire. The multiple LEDs are electrically connected to the secondary wire. At least one of the incandescent bulbs of the incandescent bulb set is placed between each two of the LEDs.

The rectifier is electrically connected to the power connector and each LED set in series.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a first embodiment of a decorative light string in accordance with the present invention;

FIG. 2 is a schematic view of a second embodiment of a decorative light string in accordance with the present invention; and

FIG. 3 is a schematic view of a third embodiment of a decorative light string in accordance with the present invention.

### DETAILED DESCRIPTION OF THE PREFERRED EMBODIMENTS

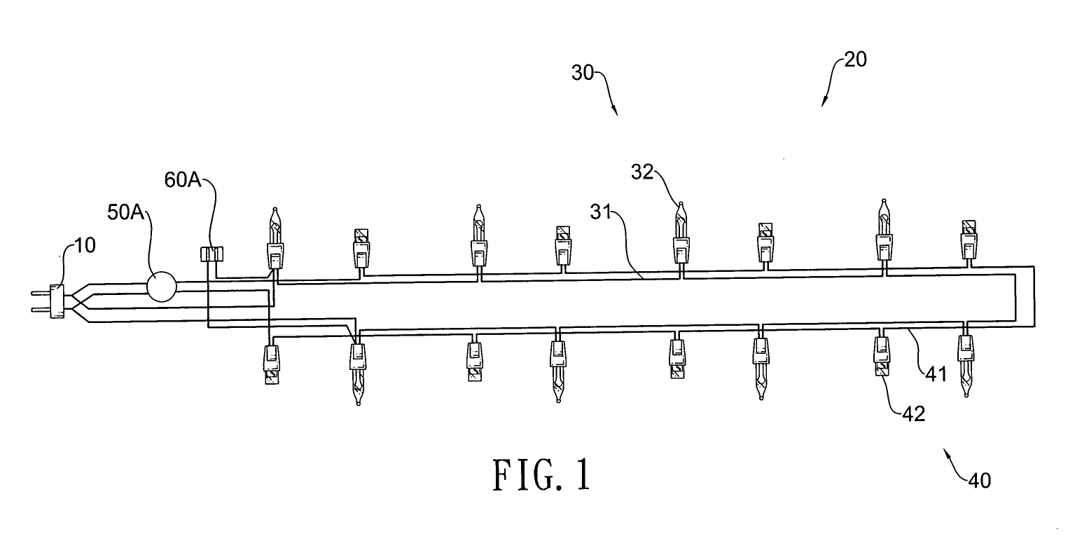

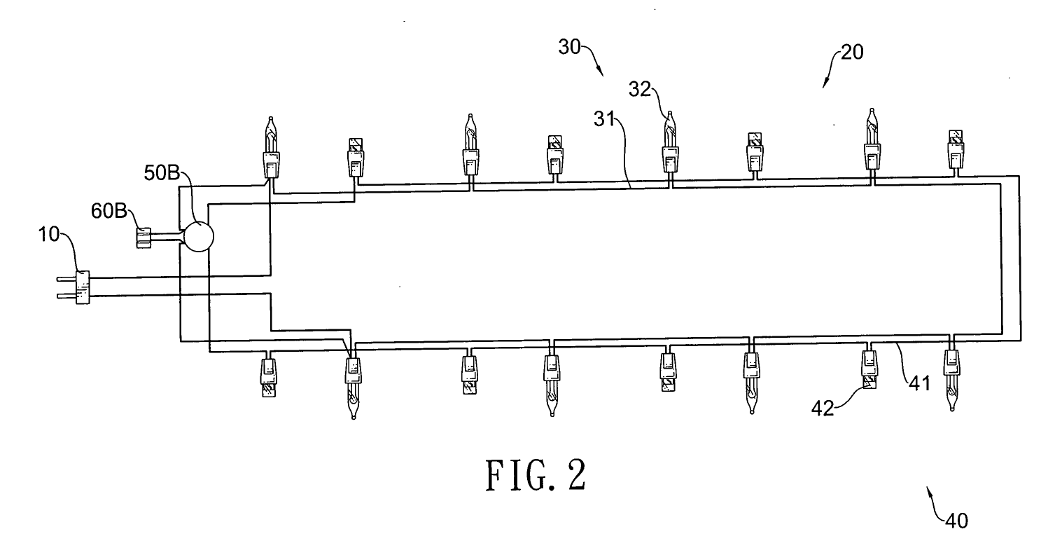

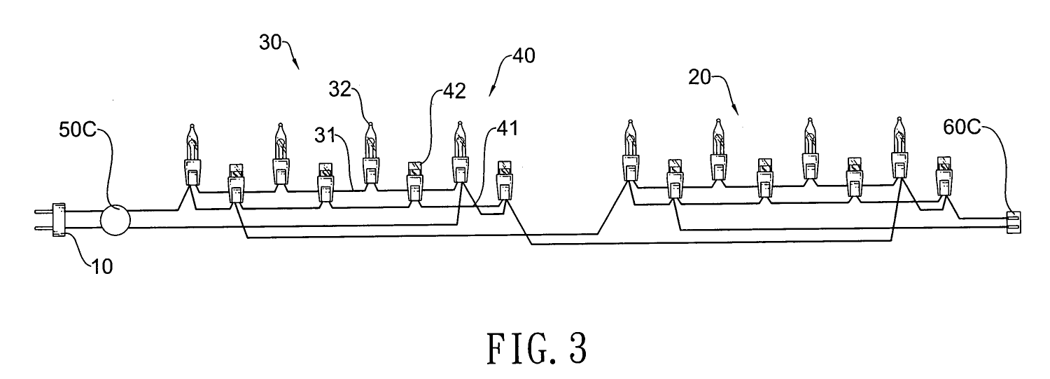

With reference to FIGS. 1 to 3, a decorative light string in accordance with the present invention comprises a power connector (10), at least one lightening unit (20), a rectifier (50A, 50B, 50C), and an optional socket (60A, 60B, 60C).

The power connector (10) may be electrically connected to an alternating current (A.C.) power source or a direct current (D.C.) power source.

The at least one lightening unit (20) is electrically connected to the power connector (10) and each one of the at least one lightening unit (20) has an incandescent bulb set (30) and a light emitting diode (LED) set (40). The decorative light string may have more than two lightening units (20) electrically connected to each other either in series or in parallel.

The incandescent bulb set (30) has a primary wire (31) and multiple incandescent bulbs (32). The primary wire (31) is electrically connected to the power connector (10). The incandescent bulbs (32) are electrically connected to the primary wire (31) and may be connected to each other in series.

The LED set (40) has a secondary wire (41) and multiple LEDs (42). The secondary wire (41) is electrically connected to the primary wire (31) and is intertwined with the primary wire (31). The LEDs (42) are electrically connected to the secondary wire (41) and may be connected to each other in series. At least one of the incandescent bulbs (31) of the incandescent bulb set (30) is placed between two of the LEDs (42).

The rectifier (50A, 50B, 50C)) is electrically connected to the power connector (10) and the LED set (40) of each lightening unit (20) in series and may be electrically connected to the incandescent bulb set (30) of each lightening unit (20).

The socket (60A, 60B, 60C) is electrically connected in parallel to one of the at least one lightening unit (20).

As the aforesaid, the present invention provides solutions for resolve the demand for a light string being decorative as an LED light string as well as being capable of preventing snow accumulation as an incandescent light string by means of a delicate design for the arrangement of a rectifier in a decorative light string in accordance with the present invention. The decorative light string in accordance with the present invention can utilize both AC and DC power supplies. In contrast, the conventional incandescent light strings and LED light strings can only utilize either AC or DC.

Based on the aforesaid, the decorative light string in accordance with the present invention has the advantages as the followings:

(1) Because the LEDs (42) and the incandescent bulbs (31) are adjacent to each other,the heat generated by the incandescent bulbs (31) effectively prevents the accumulation of snow on both the LEDs (42) and the incandescent bulbs (31)

(2) Since LEDs (42) are more energy saving than incandescent bulbs (32), the decorative light string in accordance with the present invention is more economic; and

(3) In the decorative light string in accordance with the present invention, the incandescent bulb set (30) and LED set (40) is intertwined together in advance. Therefore, it is more labor saving for utilizing the decorative light string in accordance with the present invention to decorate the Christmas trees. Moreover, less wires and electric connectors are required for the decorative light string in accordance with the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A decorative light string comprising
a power connector;
at least one lightening unit being electrically connected to the power connector and each one of the at least one lightening unit having
an incandescent bulb set having
a primary wire being electrically connected to the power connector; and
multiple incandescent bulbs being electrically connected to the primary wire; and
an LED set having
a secondary wire being electrically connected to the primary wire and being intertwined with primary wire; and
multiple LEDs being electrically connected to the secondary wire, wherein at least one of the incandescent bulbs of the incandescent bulb set is placed between two of the LEDs; and
a rectifier being electrically connected to the power connector and the LED set of each one of the at least one lightening unit in series.

2. The decorative light string as claimed in claim 1, wherein the rectifier is electrically connected to the incandescent bulb set of each one of the at least one lightening unit.

3. The decorative light string as claimed in claim 2 comprising multiple lightening units electrically connected to each other.

4. The decorative light string as claimed in claim 3, wherein the lightening units are electrically connected to each other in parallel.

5. The decorative light string as claimed in claim 2 further comprising a socket being electrically connected in parallel to one of the at least one lightening unit.

6. The decorative light string as claimed in claim 3 further comprising a socket being electrically connected in parallel to one of the lightening units.

7. The decorative light string as claimed in claim 6, wherein
the incandescent bulbs of the incandescent bulb set of each one of the at least one lightening unit are electrically connected to each other in series; and
the LEDs of the LED set of each one of the at least one lightening unit are electrically connected to each other in series.

8. The decorative light string as claimed in claim 7, wherein
the incandescent bulbs of the incandescent bulb set of each lightening unit are electrically connected to each other in series; and
the LEDs of the LED set of each lightening unit are electrically connected to each other in series.
